(19) United States
(12) Patent Application Publication
(10) Pub. No.: US 2012/0272262 A1
(43) Pub. Date: Oct. 25, 2012

(54) TRANSPORTING MEDIA PROGRAMS, ADVERTISEMENT METADATA, AND ADVERTISEMENT SELECTION CODE THROUGH DATA TRANSPORT CONTAINERS FOR USE BY AN ADVERTISEMENT INSERTION NODE

(76) Inventors: James Alexander, Highlands Ranch, CO (US); Sathiyamoorthy Dhanapal, Torrance, CA (US)

(21) Appl. No.: 13/089,612

(22) Filed: Apr. 19, 2011

(51) Int. Cl. H04N 7/025

(52) U.S. Cl. 725/32

(57) ABSTRACT

A data transport container is used to transport information from a content provider network node to an advertisement insertion network node. The data transport container encloses a media program, program metadata, advertisement metadata, and advertisement selection code. The advertisement insertion network node selects among a plurality of advertisements, which may also be received through the data transport container, in response to at least the advertisement selection code and the advertisement metadata. The selected advertisements are combined with the media program in response to the program metadata to generate a combined media program. The combined media program is communicated to a subscriber equipment unit. The data transport container may contain Material eXchange Format (MXF) encoded content. Accordingly, the advertisement insertion network node may be configured to decode MXF encoded content of the data transport container to extract the media program, the program metadata, the advertisement metadata, and the advertisement selection code into separate files.

### FIELD

The present disclosure relates to the delivery of media programs to subscriber equipment, and further relates to the insertion of advertisements into the media programs.

### BACKGROUND

Cable companies and other video-on-demand (VOD) providers are adopting a set of standards defined by the Society of Cable Telecommunications Engineers, known as the SCTE-130 standards, as a mechanism to control placement of advertisements (ads) within VOD content that is displayed on subscriber equipment units (e.g., televisions, mobile terminals, etc.).

In some architectures, an Ad Decision Manager (ADM) sends an opportunity request to an Ad Decision Service (ADS) system. The opportunity request can identify an advertisement placement opportunity location within identified VOD content. The Ad Decision Service (ADS) system uses the opportunity request to select an advertisement from among locally stored advertisements. The advertisements are separately provided by a Content Information Service (CIS) to the Ad Decision Service (ADS) system for storage. When the identified placement opportunity location is reached during playing of the VOD content identified by the opportunity request, the Ad Decision Service (ADS) system responds inserting the selected advertisement.

This architecture requires a substantial amount of coordinated planning and communications to occur between the distributed networked nodes, including the Ad Decision Manager (ADM), the Content Information Service (CIS), and the Ad Decision Service (ADS) system. While this architecture may provide an adequate advertisement delivery solution for some cable companies and other video-on-demand VOD providers, it may be prohibitively expensive and/or complex for implementation by some other providers.

### SUMMARY

Some embodiments are directed to an advertisement insertion network node. The advertisement insertion network node receives a data transport container from a content provider network node. The data transport container encloses a media program, program metadata, advertisement metadata, and advertisement selection code. The advertisement insertion network node selects among a plurality of advertisements using at least the advertisement selection code and the advertisement metadata, and combines the selected advertisements with the media program using the program metadata to generate a combined media program. The combined media program is communicated to a subscriber equipment unit.

Because the media program, program metadata, advertisement metadata, and advertisement selection code are received within a data transport container, the amount of coordinated planning and communications that are required to perform the advertisement selection and combining processes can be reduced.

The data transport container may contain Material eXchange Format (MXF) encoded content. Accordingly, the advertisement insertion network node may be configured to decode MXF encoded content of the data transport container to extract the media program, the program metadata, the advertisement metadata, and the advertisement selection code into separate files.

The advertisement insertion network node may identify advertisement placement opportunity locations within the media program using the program metadata. The node may identify time characteristics of individual ones of the advertisements using the advertisement metadata. The node may also select among the advertisements for insertion at the identified advertisement placement opportunity locations within the media program using the advertisement selection code and the identified time characteristics of the individual ones of the advertisements to generate the combined media program.

Some other embodiments are directed to a content provider network node that is configured to generate a data transport container that encloses a media program, program metadata, advertisement metadata, and advertisement selection code. The content provider network node is further configured to communicate the data transport container through a network for delivery to an advertisement insertion network node.

The content provider network node may include a MXF encoder that encodes the media program, the program metadata, the advertisement metadata, and the advertisement selection code into an MXF encoded file that is communicated as the data transport container to the advertisement insertion network node for decoding. Alternatively, the MXF encoded file may be communicated to a separate container decoder node for content decoding and forwarding to the advertisement insertion network node.

Some other embodiments are directed to related methods that are performed by an advertisement insertion network node and a content provider network node.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram that illustrates an advertisement placement system that controls the insertion of advertisements into a media program for delivery to subscriber equipment units according to some embodiments;

FIG. 2 is a block diagram of a Material Exchange Format (MXF) container decoder node that extracts information from a transported MXF container, and sends the extracted information to the advertisement insertion network node of FIG. 1 according to some embodiments;

FIG. 3 is a block diagram of an alternate embodiment to FIG. 2 in which the advertisement insertion network node includes a MXF container decoder node for extracting information from a transported MXF container according to some embodiments;

FIG. 4 is a block diagram of a MXF container decoder node that extracts information from a transported MXF container, and sends the extracted information to the advertisement insertion network node of FIG. 1 for selection among advertisements in a local advertisement database according to some embodiments;

FIG. 5 is a block diagram of an alternate embodiment to FIG. 4 in which the advertisement insertion network node includes a MXF container decoder node for extracting information from a transported MXF container and for use in selecting among advertisements in a local advertisement database according to some embodiments;

FIG. 6 is a data flow diagram that illustrates operations and methods performed by the content provider network node, the advertisement insertion network node, and the subscriber equipment unit of FIG. 1 according to some embodiments;

FIGS. 7-17 are flowcharts that illustrate various example operations and methods of the content provider network node and the advertisement insertion network node of FIG. 1 according to some embodiments;

FIG. 18 is a block diagram of the content provider network node of FIG. 1 configured according to some embodiments; and

FIG. 19 is a block diagram of the advertisement insertion network node of FIG. 1 configured according to some embodiments.

### DETAILED DESCRIPTION

The invention will now be described more fully hereinafter with reference to the accompanying drawings, in which embodiments of the invention are shown. This invention may, however, be embodied in many different forms and is not to be construed as limited to the embodiments set forth herein.

Various embodiments are directed to controlling the distribution and insertion of advertisements into a media program for delivery to subscriber equipment units. Coordination and communications between various network nodes can be simplified through the use of data transport containers that contain a media program, program metadata, advertisement metadata, and advertisement selection code. Although various embodiments are described herein in the context of using a Material Exchange Format (MXF) for encoding the content of a data transport container, embodiments are not limited using data transport containers having MXF coding. Instead, any format container may be used that can transport a media program, program metadata, advertisement metadata, and advertisement selection code, which may originally reside in a plurality of separate files, through a delivery network as combined (e.g., encoded) data, such as within a single file. MXF is a standard container format developed for the interchange of audiovisual material, including metadata, and is defined by a set of standards promulgated by the Society of Motion Picture and Television Engineers (SMPTE), including as document SMPTE 377.

Example Advertisement Placement System:

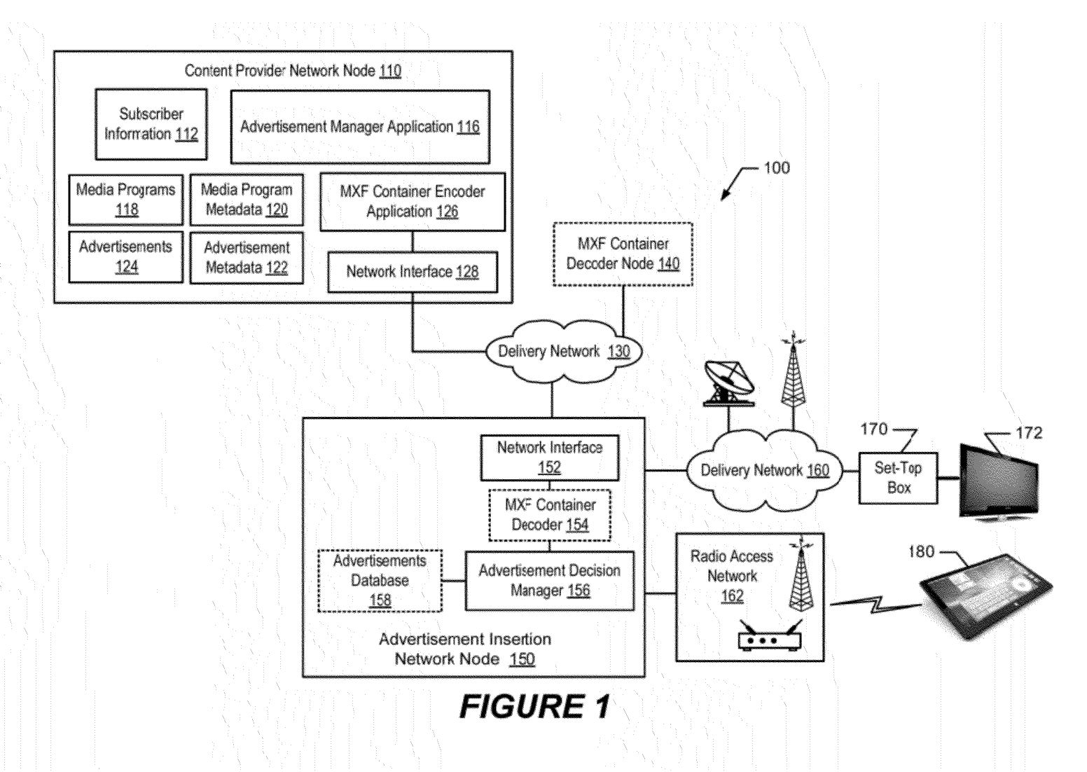

FIG. 1 is a block diagram that illustrates an example advertisement placement system 100 that includes a content provider network node 110 and an advertisement insertion network node 150 that are communicatively connected through a delivery network 130. Although a single content provider network node 110 and advertisement insertion network node 150 have been illustrated for ease of illustration and explanation, is to be understood that the respective functionality described herein may be spread across more and other types of network nodes.

The content provider network node 110 may correspond to a back office of a cable television service provider, a satellite television service provider, a terrestrial radio transmission television service provider, an Internet/other network service provider. The content provider network node 110 is configured to deliver media programs 118 through the delivery network 130 and the advertisement insertion network node 150 to a plurality of subscriber equipment units 170 and 180. A media program 118 may be delivered responsive to commands received from one of the subscriber equipment units 170 and 180, such in response to video-on-demand (VOD) commands and/or as linear media content simultaneously delivered to a plurality of subscriber equipment units 170 and 180.

The content provider network node 110 can include media programs 118, media program metadata 120, advertisements 124, advertisement metadata 122, which may reside in separate storage files in a memory (e.g., mass memory such as a disk drive based computer server) of the node 110. The media programs 118 may each correspond to different movie, television program, other video media, and/or audio media. The media program metadata 120 can identify advertisement placement opportunity locations within the media programs 118, such as by identifying the beginning and ending locations of segments (e.g., scenes within a program). The advertisements 124 may correspond to audio-video television advertisements, video advertisements, audio advertisements, or textual advertisements (e.g., textual advertisement descriptions for display as an overlay on a video stream). The advertisement metadata 122 can identify time characteristics of individual ones of the advertisements, such as the start and stop locations and/or playing length of individual advertisements.

The content provider network node 110 further includes an advertisement manager application 116 that generates advertisement selection code that is used by the advertisement insertion network node 150 to select among the advertisements for insertion at the identified advertisement placement opportunity locations within a media program. The advertisement selection code may cause the advertisement insertion network node 150 to make predefined advertisement insertion decisions and/or real-time fulfillment advertisement insertion decisions.

The advertisement selection code may, for example, define: 1) rate(s) at which advertisements are to be inserted; 2) how many advertisements are to be inserted; 3) play length(s) of advertisements that are to be inserted; 4) times of day when advertisements are to be inserted; 5) characteristics of advertisements that are to be inserted (e.g., particular advertiser brands and/or content advertisement campaigns). The advertisement selection code may be uniquely defined for different ones of the media programs 118 and/or may be commonly defined for some or all of the media programs 118.

The content provider network node 110 may further include subscriber information 112, and the advertisement selection code may identify subscriber related demographics or other information that can be used by the advertisement insertion network node 150 to select advertisements that are targeted for a particular subscriber associated with one of the subscriber equipment units 170 and 180.

The content provider network node 110 encloses a media program 118, associated media program metadata 120, advertisement metadata 122, and generated advertisement selection code within a data transport container. In some embodiments, a MXF container encoder application 126 encodes the media program 118, the associated media program metadata 120, advertisement metadata 122, and the generated advertisement selection code as MXF encoded content within a single data file. The MXF encoded content is then transported within a MXF container through a network interface 128 into the delivery network 130.

Scenario 1—Networked MXF Container Decoder Node Decodes MXF Container:

In some embodiments, a MXF container decoder node 140 resides in the communication pathway between the content provider network node 110 and the advertisement insertion network node 150 to decode and extract the contents of the MXF container into separate files. The separate files are then transported through the delivery network 130 to the advertisement insertion network node 150.

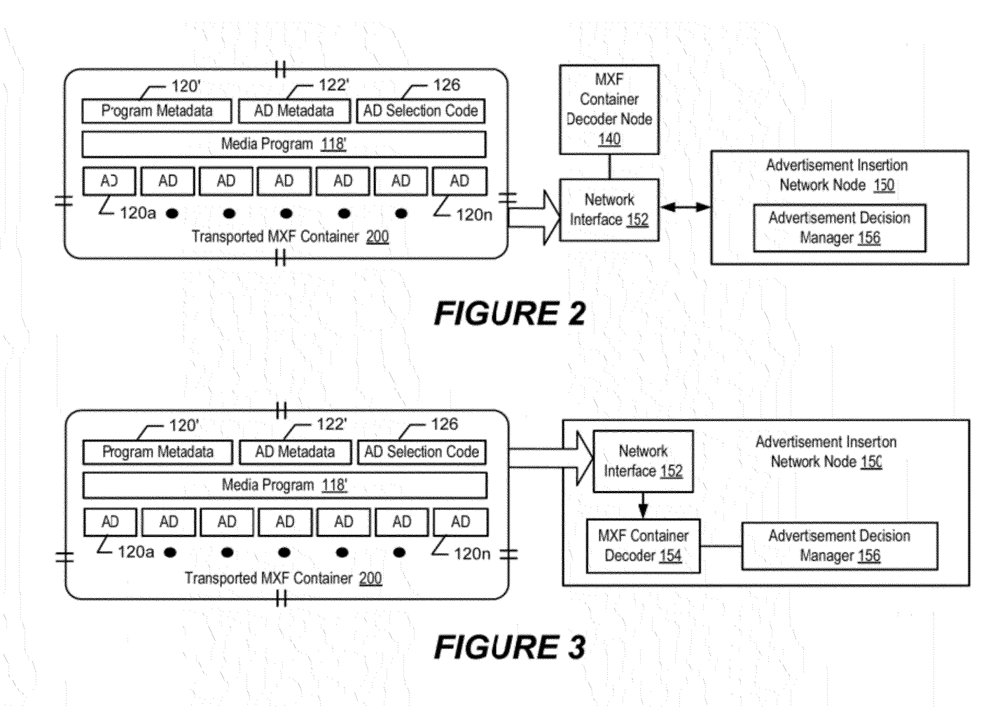

FIG. 2 is a block diagram that illustrates the example contents of a MXF container 200 that is transported from the content provider network node 110 through the delivery network 130 to the MXF container decoder node 140. The MXF container 200 includes a media program 118′, corresponding program metadata 120′, advertisement (AD) metadata 122′, advertisements 124a-124n (n is a positive integer), and advertisement selection code 126, all of which have been encoded as MXF content within the same MXF container 200, which may correspond to a single data file.

The MXF container decoder node 140 receives the MXF container 200 through a network interface 152 via the delivery network 130. The MXF container decoder node 140 is configured to decoding and extract the media program 118′, the corresponding program metadata 120′, the advertisement (AD) metadata 122′, the advertisements 124a-124n, and the advertisement selection code 126 into more than one file or each into separate files. The MXF container decoder node 140 then communicates the extracted contents (118′, 120′, 122′, 124a-124n, and 126) through the network interface 152 and the delivery network 130 to the advertisement insertion network node 150.

An advertisement decision manager 156 identifies advertisement placement opportunity locations within the media program in response to the program metadata 120′. The advertisement decision manager 156 identifies time characteristics (e.g., start and stop locations and/or playing length) of individual ones of the advertisements 124a-124n in response to the advertisement metadata 122′. The advertisement decision manner 156 also selects among the advertisements 124a-124n, and inserts the selected advertisement(s) at the identified advertisement placement opportunity location(s) within the media program 118′ in response to the advertisement selection code 126 and the identified time characteristics of the individual ones of the advertisements 124a-124n to generate a combined media program. For example, when the media program is a VOD program, the manager 156 can insert the selected advertisements into the VOD program at the advertisement placement opportunity locations(s), and stream the combined VOD program to one of the subscriber equipment units 170/180 that requested the VOD program.

The advertisement decision manager 156 may select among the advertisements according to one or more rules defined by the advertisement selection code 126. The code 126 may cause the manager 156 to select among the advertisements according to a defined sequence, such as a round-robin sequence, and/or to select advertisements containing content that is targeted to the viewing habits of a subscriber (e.g., determined by comparison of the advertisement metadata 122′ to the subscriber information 112) and/or that is targeted to the content of the media program 118′ near the advertisement placement location (e.g., determined by comparison of the advertisement metadata 122′ to the program metadata 120′).

The combined media program is communicated to one or more of the subscriber equipment units 170 and 180, which may be identified by an equipment identifier contained in the advertisement selection code 126. The combined media program may be communicated through the delivery network 160 and/or another network, which may include cable television network equipment, satellite network equipment, terrestrial television broadcast equipment, and/or Internet/other data network equipment.

As shown in FIG. 1, the subscriber equipment unit 170 may be a set-top-box 170 that is controlled by a user to request delivery of media content (e.g., television program/movie) and to receive the combined media program for display on a display device 172 (e.g., LCD/plasma/cathode ray tube/other video display) that may be part of the set-top box 170 and/or may be connected to the set-top box 170.

The other subscriber equipment unit 180 may receive the combined media program via a wireless air interface to a radio access network 162 that is communicatively connected to the network interface 152. The radio access network 162 may contain one or more cellular radio access technology systems that may include, but are not limited to, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, Universal Mobile Telecommunications System (UMTS), and/or 3GPP LTE (3^{rd} Generation Partnership Project Long Term Evolution). The radio access network 162 may alternatively or additional communicate with the subscriber equipment unit 180 through a Wireless Local Area Network (i.e., IEEE 802.11) interface, a Bluetooth interface, and/or other radio frequency (RF) interface.

The subscriber equipment units 170 and 180 may correspond to a video gaming device or console, a desktop computer, a laptop computer, a tablet computer, and/or a palmtop computer. The wireless subscriber equipment unit 170 may additionally correspond to a cellular phone or other wireless communication terminal.

Scenario 2—Advertisement Insertion Network Node Performs MXF Container Decoding:

In some other embodiments, the advertisement insertion network node 150 includes an MXF container decoder 154 that decodes the MXF container 200 to extract the media program 118′, the corresponding program metadata 120′, the advertisement (AD) metadata 122′, the advertisements 124a-124n, and the advertisement selection code 126 into more than one file or separate files. FIG. 3 is a block diagram of the example advertisement insertion network node 150 containing the MXF container decoder 154. As shown in FIG. 3, the MXF container 200 can be communicated from the content provider network node 110 to the advertisement insertion network node 150 without passing through an intervening MXF container decoder node 140.

Accordingly, the MXF container decoder 154 receives the MXF container 200 through the network interface 152, extracts the contents therefrom, and provides extracted contents advertisement decision manager 156. The advertisement decision manager 156 may operate as described above regarding FIG. 2 to generate a combined media program that is communicated to one or more of the subscriber equipment units 170 and 180.

Scenario 3—Networked MXF Container Decoder Node Decodes MXF Container and Advertisement Insertion Network Node Contains Advertisement Database:

In some other embodiments, the advertisement insertion network node 150 includes a database 158 of advertisements. The advertising decision manager 156 may operate as described above regarding FIG. 2, except that it can select at least one advertisement, from among the advertisements that are stored in the database 158, to generate a combined media program that is communicated to one or more of the subscriber equipment units 170 and 180.

The database 158 may store a cache of advertisements that were earlier played through one or more of the subscriber equipment units 170 and 180. For example, the advertisement insertion network node 150 may store advertisements in the database 158 for subsequent use/reuse for insertion into the media program 118′ to generate the combined media program for communication to one or more of the subscriber equipment units 170 and 180.

Alternatively or additionally, a MXF container (e.g., container 200) may include more advertisements (e.g., extra advertisements) that those that are intended to be used for a single playing of the media program 118′. When the media program 118′ is played again, the advertisement decision manager 156 may select different ones of the advertisements (e.g., the extra advertisements), which may not have yet been played, for insertion into the media program 118′. Accordingly, a user may see (via the subscriber equipment units 170 and/or 180) at least some different advertisements played during repeated viewings of the combined media program received from the advertisement insertion network node 150.

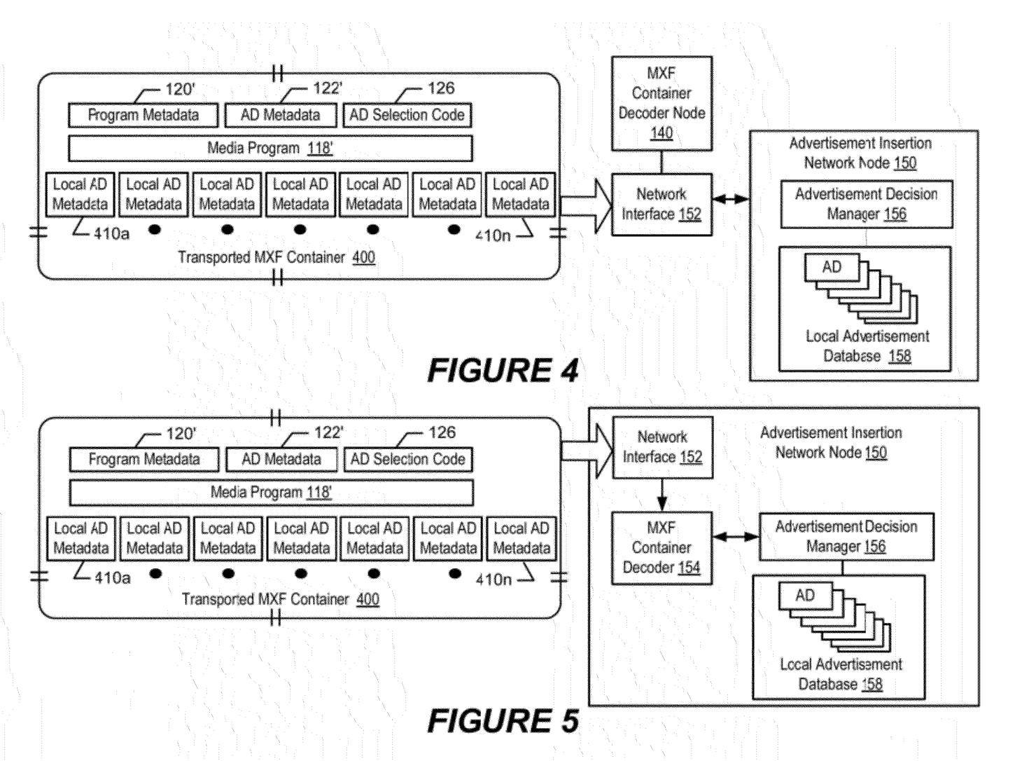

Referring to FIG. 4, the advertisements may be received by the advertisement insertion network node 150 through one or more communications that are separate and distinct from a MXF container 400 that transported the media program 118′, the corresponding program metadata 120′, the advertisement (AD) metadata 122′, and the advertisement selection code 126. The MXF container 400 further encloses (encoded with the other contents 118′, 120, 122′, and 126) local advertisement metadata 410a-410n (where n is a positive integer) that contains addressable pointers to the advertisements stored in the database 158.

When the MXF container decoder node 140 is separate from the advertisement insertion network node 150, as shown in FIG. 4, the content provider network node 110 communicates the MXF container 400 through the delivery network 130 to the MXF container decoder node 140. The decoder node 140 decodes the contents of the MXF container 400 and extracts the media program 118′, the corresponding program metadata 120′, the advertisement (AD) metadata 122′, the advertisement selection code 126, and the local advertisement metadata 410a-410n into two or more files, and may store each of the extracted contents (118′, 120′, 122′, 126, and 410a-410n) into separate files. The extracted contents are communicated through the network interface 152 and the delivery network 130 to the advertisement insertion network node 150.

The advertisement decision manager 156 operates as describe above for FIG. 2, except that the manager 156 now additionally or alternatively selects among the advertisements stored in the database 158, using the addressable pointers provided by the extracted local advertisement metadata 410a-410n to read from defined memory locations or query defined records in the database 111 to retrieve the corresponding advertisements.

Accordingly, the advertisement decision manager 156 may select among the advertisements in the database 158 (and may further select among other advertisements which may be received in the container 400) according to one or more rules defined by the advertisement selection code 126. The code 126 may cause the manager 156 to select among the advertisements according to a defined sequence, such as a round-robin sequence, and/or to select advertisements containing content that is targeted to the viewing habits of a subscriber (e.g., determined by comparison of the advertisement metadata 122′ to the subscriber information 112) and/or that is targeted to the content of the media program 118′ near the advertisement placement location (e.g., determined by comparison of the advertisement metadata 122′ to the program metadata 120′).

The selected advertisement(s) are inserted at the identified advertisement placement opportunity location(s) within the media program 118′ to generate a combined media program, which is communicated to one or more of the subscriber equipment units 170 and 180.

Scenario 4—Advertisement Insertion Network Node Performs MXF Container Decoding and Contains Advertisement Database:

FIG. 5 is a block diagram of the advertisement insertion network node 150 that is configured according to some other embodiments to include the database 158 of advertisements described above for FIG. 4 and further includes the MXF container decoder 154 that operates as described above for FIG. 3. As shown in FIG. 4, the MXF container 400 can be communicated from the content provider network node 110 to the advertisement insertion network node 150 without passing through an intervening MXF container decoder node 140.

The advertisement decision manager 156 operates as describe above for FIG. 2, except that the manager 156 now additionally or alternatively selects among the advertisements stored in the database 158 using the addressable pointers provided by the extracted local advertisement metadata 410a-410n. The selected advertisement(s) are inserted at the identified advertisement placement opportunity location(s) within the media program 118′ to generate a combined media program, which is communicated to one or more of the subscriber equipment units 170 and 180.

Operations and Methods in the Advertisement Placement System:

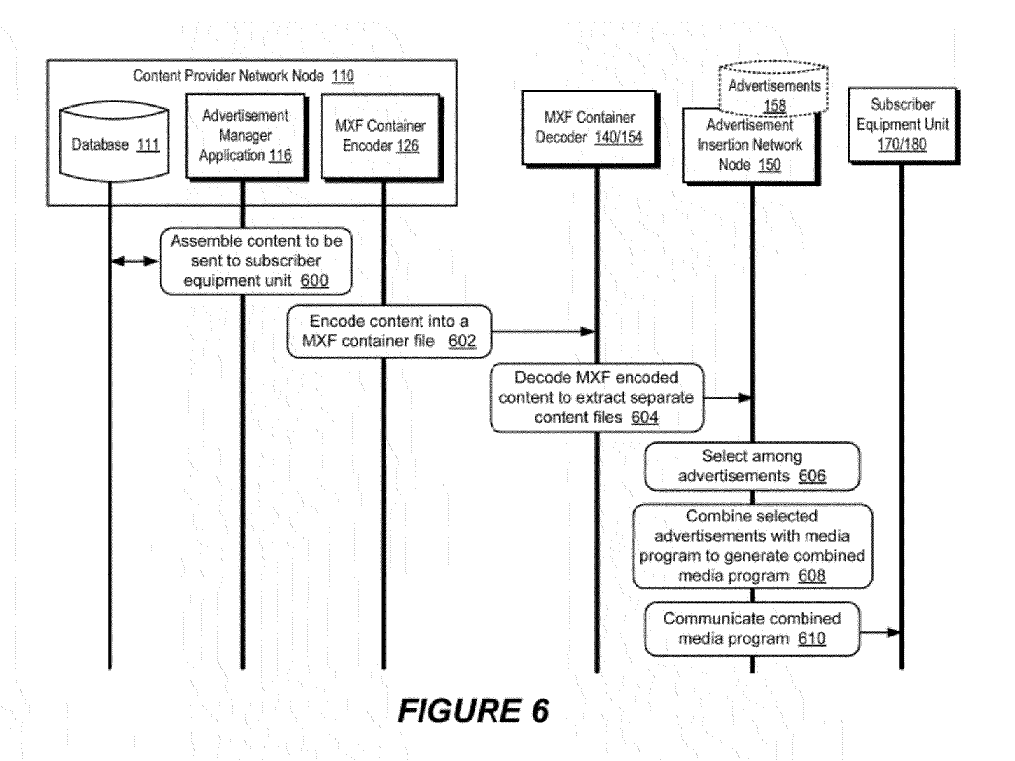

FIG. 6 is a data flow diagram that illustrates operations and methods performed by the content provider network node 110, the advertisement insertion network node 150, and one of the subscriber equipment units 170/180 of advertisement placement system 100 in FIG. 1 according to some embodiments. Referring to FIG. 6, the advertisement manager application 116 accesses a database 111 to assemble (block 600) content that is to be sent to a subscriber equipment unit. The content may include a media program, program metadata, advertisement metadata, advertisement selection code, and may further include advertisements (e.g., as shown in FIGS. 2 and 3) and/or local advertisement metadata providing pointers to locally stored advertisements (e.g., as shown in FIGS. 4 and 5).

The MXF container encoder 126 encodes (block 602) the assembled content into a MXF container file, which is communicated to the MXF container decoder 140/154. The MXF container decoder 140/154 decodes and extracts (block 604) the content from the MXF container file. The advertisement insertion network node 150 uses the extracted content to select among the advertisements (block 606) that may have been received through the MXF container file and/or which may reside in a local advertisement database 158. The advertisement insertion network node 150 combines (block 608) the selected advertisements with the media program to generate a combined media program. The combined media program is communicated (block 610) to the subscriber equipment unit 170/180.

### FURTHER EMBODIMENTS

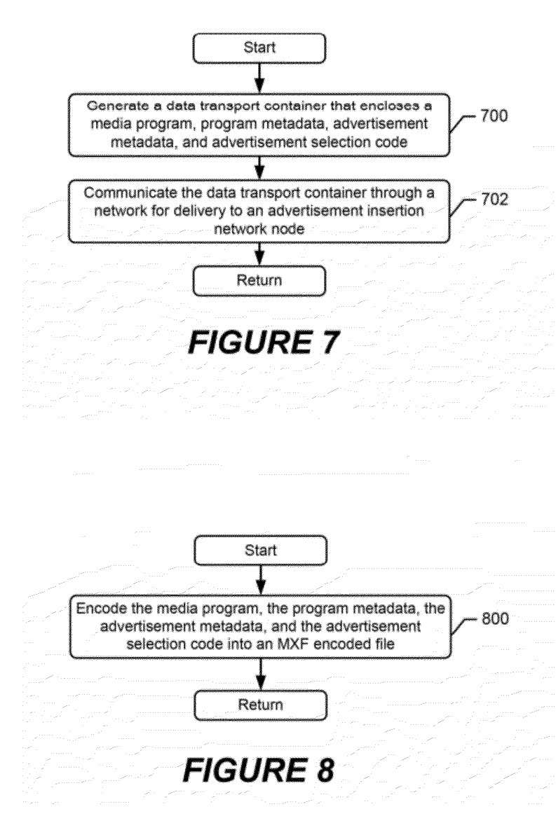

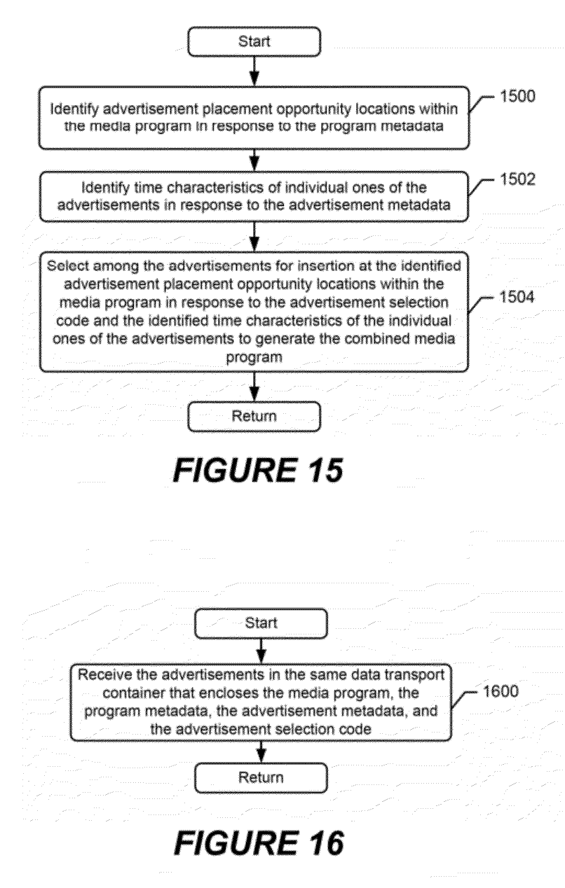

FIGS. 7-17 are flowcharts that illustrate operations and methods of the content provider network node 110 and the advertisement insertion network node 150 of FIG. 1 according to some embodiments.

Referring to FIG. 7, the content provider network node 110 generates (block 700) the data transport container enclosing a media program, program metadata, advertisement metadata, and advertisement selection code. The data transport container is communicated (block 702) through the network 130 for delivery to the advertisement insertion network node 150.

Referring to FIG. 8, in some embodiments the media program, the program metadata, the advertisement metadata, and the advertisement selection code are encoded (block 800) into an MXF encoded file.

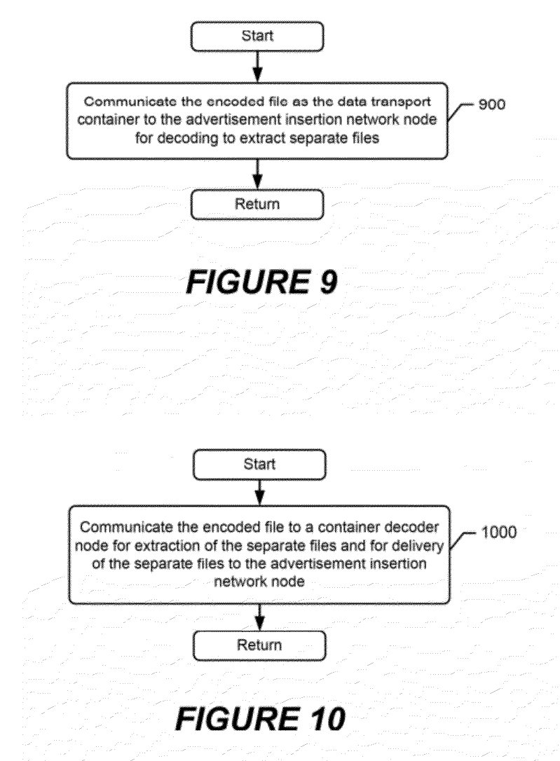

When the advertisement insertion network node 150 includes a decoder (e.g. as shown in FIG. 3), the data transport container can be communicated directly from the content provider network node 110 to the advertisement insertion network node 150 without traveling through an external container decoder node. For example, referring to FIG. 9, the encoded file is communicated (block 900) as the data transport container to the advertisement insertion network node 150 for decoding to extract the content into separate files.

In contrast, when the container decoder is external to the advertisement insertion network node 150 (e.g. as shown in FIG. 2), the data transport container can be communicated from the content provider network node 110 to the external container decoder. For example, referring to FIG. 10, the encoded file is communicated (block 1000) to the container decoder node 140 for extraction of the content into separate files and for delivery of the separate files to the advertisement insertion network node 150.

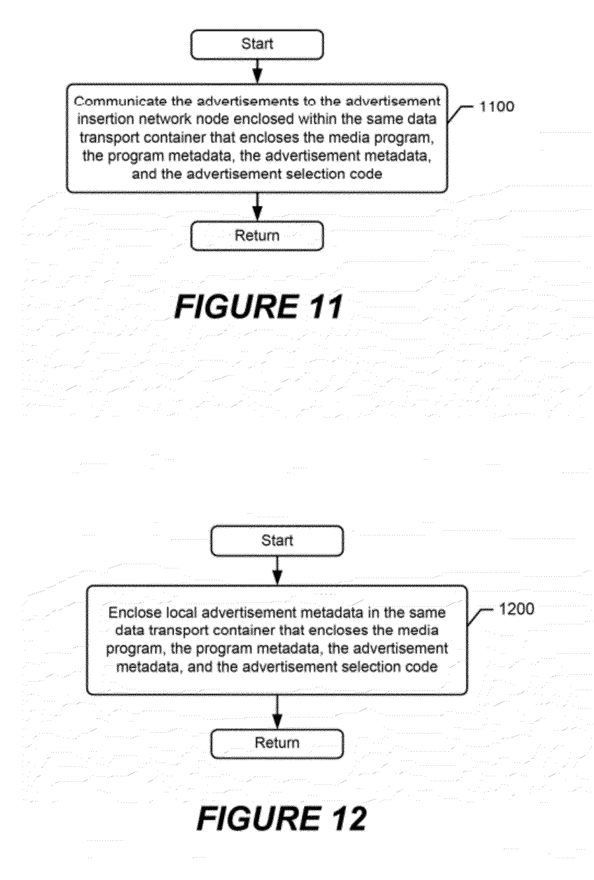

Referring to FIG. 11, in some embodiments, the advertisements are communicated (block 1100) to the advertisement insertion network node enclosed within the same data transport container that encloses the media program, the program metadata, the advertisement metadata, and the advertisement selection code

In some embodiments, the advertisements are received separate from the data transport container and are stored in a local advertisement database 158 (e.g. as shown in FIGS. 4 and 4). For example, referring to FIG. 12, local advertisement metadata is communicated from the content provider network node 110 to the advertisement insertion network node 150 enclosed (block 1200) in the same data transport container that encloses the media program, the program metadata, the advertisement metadata, and the advertisement selection code.

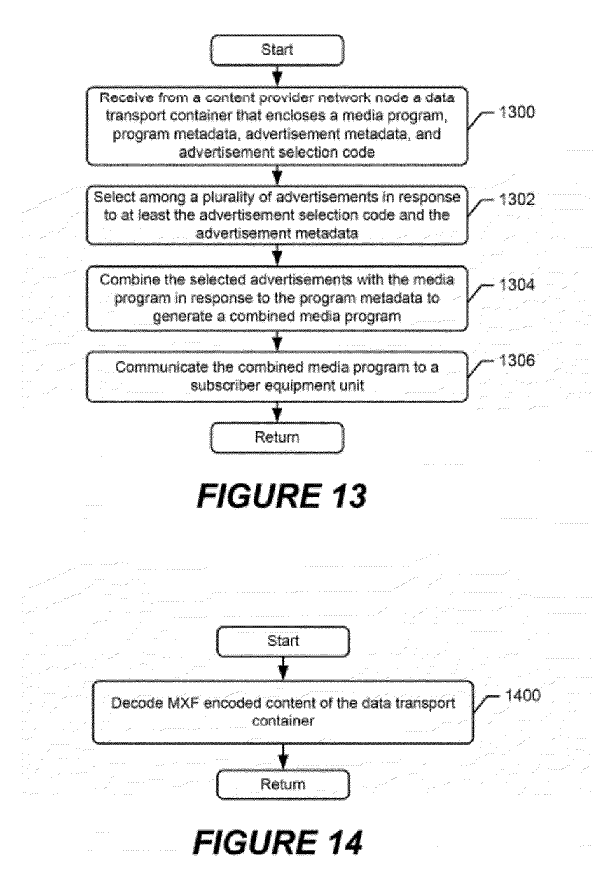

FIG. 13 illustrates operations that may be performed by the advertisement insertion network node 150 to receive and use the content of the transport container. A data transport container is received (block 1300) that encloses a media program, program metadata, advertisement metadata, and advertisement selection code. A selection is performed (block 1302) among a plurality of advertisements in response to at least the advertisement selection code and the advertisement metadata. The selected advertisements are combined (block 1304) with the media program in response to the program metadata to generate a combined media program. The combined media program are communicated (block 1306) to a subscriber equipment unit.

In some embodiments, the advertisement insertion network node 150 can decode MXF encoded content of the data transport container, as shown in block 1400 of FIG. 14.

In some embodiments, the advertisement insertion network node 150 identifies (block 1500) advertisement placement opportunity locations within the media program in response to the program metadata. Time characteristics of individual ones of the advertisements are identified (block 1502) in response to the advertisement metadata. The advertisement insertion network node 150 selects (block 1504) among the advertisements for insertion at the identified advertisement placement opportunity locations within the media program in response to the advertisement selection code and the identified time characteristics of the individual ones of the advertisements to generate the combined media program.

Referring to FIG. 16, in some embodiments advertisements are received (block 1600) in the same data transport container that encloses the media program, the program metadata, the advertisement metadata, and advertisement selection code.

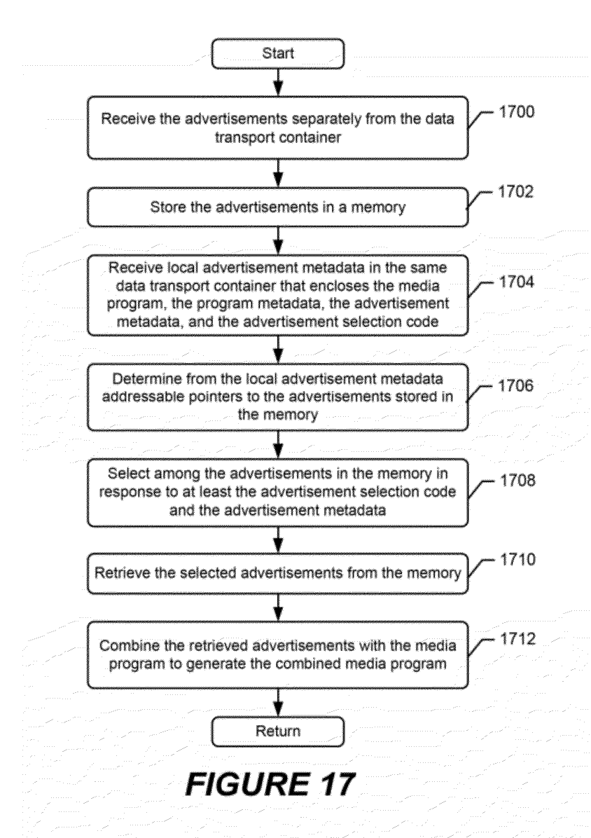

Referring to FIG. 17, in some embodiments the advertisements are received (block 1700) by the advertisement insertion network node 150 separately from the data transport container. Advertisements are locally stored (block 1702) in the advertisement insertion network node (e.g. in the advertisement database 158). Local advertisement metadata is received (block 1704) in the same data transport container that encloses the media program, program metadata, the advertisement metadata, and advertisement selection code. The advertisement insertion network node 150 determines (block 1706) from the local advertisement metadata, addressable pointers to advertisements that are stored in the memory. The advertisement insertion network node 150 selects (block 1708) among advertisements in the memory in response to at least the advertisement selection code and advertisement metadata. The selected advertisements are retrieved (block 1710) from the memory, and they are combined (block 1712) with the media program to generate a combined media program. The combined media program can be communicated to one or more of the subscriber equipment units 170 and 180.

Example Content Provider Network Node Configuration:

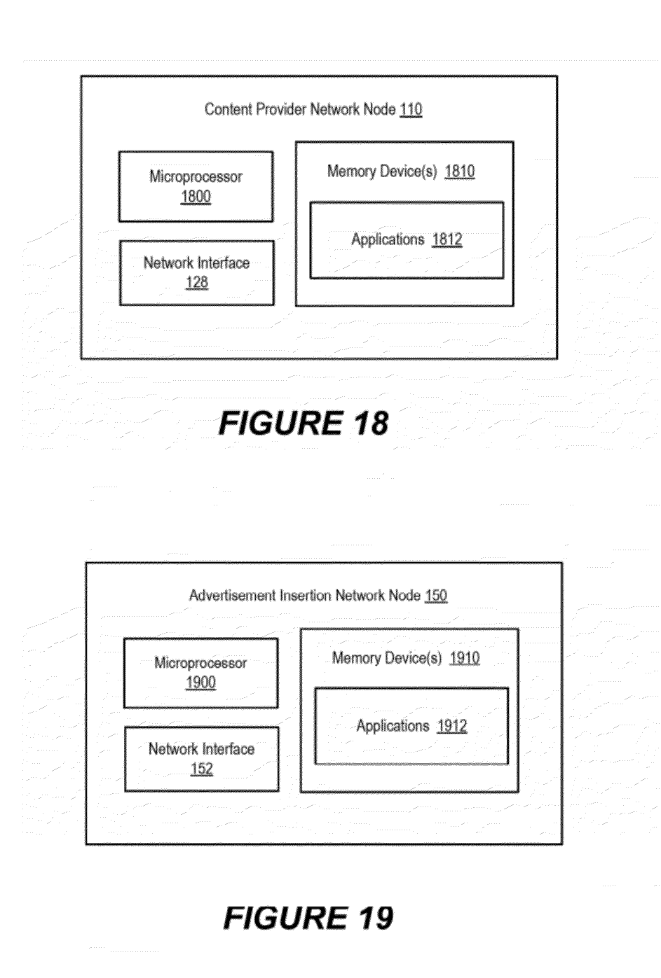

FIG. 18 is a block diagram of the content provider network node 110 of FIG. 1 that is configured according to some embodiments. Referring to FIG. 18, the content provider network node 110 may include a microprocessor 1800, memory device(s) 1810, and a network interface 128.

The memory device(s) 1810 may include mass storage devices, such as one or more disk drives and/or semiconductor memory, that contain instructions that are executable by the microprocessor 1800 and may further include information forming at least part of the media programs 118, media program metadata 120, advertisements 124, advertisement metadata 122, and/or subscriber information 112.

The microprocessor 1800 may include one or more data processing circuits, such as a general purpose and/or special purpose processor with on-board and/or separate memory devices. The microprocessor 1800 is configured to execute computer program instructions in applications 1812 within a memory, which is described below as a computer readable medium and which may reside within the memory device(s) 1810, to perform at least some of the functionality described herein for the content provider network node 110, including the advertisement manager application 116 and the MXF container encoder application 126.

Example Advertisement Insertion Network Node Configuration:

FIG. 19 illustrates a block diagram of the advertisement insertion network node 150 of FIG. 1 that is configured according to some embodiments. Referring to FIG. 19, the content provider network node 110 may include a microprocessor 1900, memory device(s) 1910, and a network interface 152.

The memory device(s) 1910 may include mass storage devices, such as one or more disk drives and/or semiconductor memory, that contain instructions that are executable by the microprocessor 1900. The microprocessor 1900 may include one or more data processing circuits, such as a general purpose and/or special purpose processor with on-board and/or separate memory devices. The microprocessor 1900 is configured to execute computer program instructions in applications 1912 within a memory, which is described below as a computer readable medium and which may reside within the memory device(s) 1910, to perform at least some of the functionality described herein for the advertisement insertion network node 150, including the advertisement decision manager 156 and possibly further including the MXF container decoder 154.

### FURTHER EMBODIMENTS AND DEFINITIONS

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. An advertisement insertion network node that is configured to:
receive, from a content provider network node, a data transport container that encloses a media program, program metadata, advertisement metadata, and advertisement selection code;
select among a plurality of advertisements in response to at least the advertisement selection code and the advertisement metadata;
combine the selected advertisements with the media program in response to the program metadata to generate a combined media program; and
communicate the combined media program to a subscriber equipment unit.

2. The advertisement insertion network node of claim 1, further configured to decode Material eXchange Format, MXF, encoded content of the data transport container to extract the media program, the program metadata, the advertisement metadata, and the advertisement selection code into separate files.

3. The advertisement insertion network node of claim 1, further configured to receive the data transport container as a single encoded file enclosing the media program, the program metadata, the advertisement metadata, and the advertisement selection code, and to decode the encoded content of the single encoded file to extract the media program, the program metadata, the advertisement metadata, and the advertisement selection code into separate files.

4. The advertisement insertion network node of claim 1, further configured to:
identify advertisement placement opportunity locations within the media program in response to the program metadata;
identify time characteristics of individual ones of the advertisements in response to the advertisement metadata; and
select among the advertisements for insertion at the identified advertisement placement opportunity locations within the media program in response to the advertisement selection code and the identified time characteristics of the individual ones of the advertisements to generate the combined media program.

5. The advertisement insertion network node of claim 1, further configured to receive the advertisements in the same data transport container that encloses the media program, the program metadata, the advertisement metadata, and the advertisement selection code.

6. The advertisement insertion network node of claim 1, further configured to:
receive the advertisements separately from the data transport container;
store the advertisements in a memory;
select among the advertisements in the memory in response to at least the advertisement selection code and the advertisement metadata;
retrieve the selected advertisements from the memory; and
combine the retrieved advertisements with the media program to generate the combined media program.

7. The advertisement insertion network node of claim 6, further configured to:
receive local advertisement metadata in the same data transport container that encloses the media program, the program metadata, the advertisement metadata, and the advertisement selection code; and
determine from the local advertisement metadata addressable pointers to the advertisements stored in the memory.

8. The advertisement insertion network node of claim 1, wherein the media program comprises a video on demand program, and the advertisement insertion network node is further configured to select among the advertisements and to insert the selected advertisements into the video-on-demand program in response to instructions provided by the advertisement selection code.

9. A content provider network node that is configured to:
generate a data transport container that encloses a media program, program metadata, advertisement metadata, and advertisement selection code; and
communicate the data transport container through a network for delivery to an advertisement insertion network node.

10. The content provider network node of claim 9, comprising:
an encoder that is configured to encode the media program, the program metadata, the advertisement metadata, and the advertisement selection code into an encoded file; and
a network interface that is configured to communicate the encoded file as the data transport container through the network for delivery to the advertisement insertion network node.

11. The content provider network node of claim 10, wherein:
the encoder comprises a Material eXchange Format, MXF, encoder that encodes the media program, the program metadata, the advertisement metadata, and the advertisement selection code into an MXF encoded file.

12. The content provider network node of claim 10, further configured to communicate through the network interface the encoded file as the data transport container to the advertisement insertion network node for decoding to extract the media program, the program metadata, the advertisement metadata, and the advertisement selection code into separate files.

13. The content provider network node of claim 10, further configured to communicate through the network interface the encoded file to a container decoder node for extraction of the media program, the program metadata, the advertisement metadata, and the advertisement selection code into separate files and for delivery of the separate files to the advertisement insertion network node.

14. The content provider network node of claim 9, wherein:
the program metadata identifies advertisement placement opportunity locations within the media program;
the advertisement metadata identifies time characteristics of each of the advertisements; and
the advertisement selection code contains instructions that cause the advertisement insertion network node to select among a plurality of advertisements for insertion at the identified advertisement placement opportunity locations within the media program to generate a combined media program for communication to a subscriber equipment unit.

15. The content provider network node of claim 9, further configured to communicate the advertisements to the advertisement insertion network node enclosed within the same data transport container that encloses the media program, the program metadata, the advertisement metadata, and the advertisement selection code.

16. The content provider network node of claim 9, further configured to:
enclose local advertisement metadata in the same data transport container that encloses the media program, the program metadata, the advertisement metadata, and the advertisement selection code,
wherein the local advertisement metadata provides addressable pointers to advertisements that are stored in a memory of the advertisement insertion network node.

17. A method performed by an advertisement insertion network node, the method comprising:
receiving from a content provider network node a data transport container that encloses a media program, program metadata, advertisement metadata, and advertisement selection code;
selecting among a plurality of advertisements in response to at least the advertisement selection code and the advertisement metadata;
combining the selected advertisements with the media program in response to the program metadata to generate a combined media program; and
communicating the combined media program to a subscriber equipment unit.

18. The method of claim 17, further comprising:
decoding Material eXchange Format, MXF, encoded content of the data transport container to extract the media program, the program metadata, the advertisement metadata, and the advertisement selection code into separate files;
identifying advertisement placement opportunity locations within the media program in response to the program metadata;
identifying time characteristics of individual ones of the advertisements in response to the advertisement metadata; and
selecting among the advertisements for insertion at the identified advertisement placement opportunity locations within the media program in response to the advertisement selection code and the identified time characteristics of the individual ones of the advertisements to generate the combined media program.

19. A method performed by a content provider network node, the method comprising:
generating a data transport container that encloses a media program, program metadata, advertisement metadata, and advertisement selection code; and
communicating the data transport container through a network for delivery to an advertisement insertion network node.

20. The method of claim 19, further comprising:
encoding the media program, the program metadata, the advertisement metadata, and the advertisement selection code into a Material eXchange Format, MXF, encoded file; and
communicating the MXF encoded file as the data transport container through the network for delivery to the advertisement insertion network node,
wherein the program metadata identifies advertisement placement opportunity locations within the media program,
wherein the advertisement metadata identifies time characteristics of each of the advertisements, and
wherein the advertisement selection code contains instructions that cause the advertisement insertion network node to select among a plurality of advertisements for insertion at the identified advertisement placement opportunity locations within the media program to generate a combined media program for communication to a subscriber equipment unit.
